(19) United States
(12) Patent Application Publication
(10) Pub. No.: US 2026/0066480 A1
(43) Pub. Date: Mar. 5, 2026

(54) BATTERY WITH WELDED BUS BAR CONNECTIONS

(71) Applicant: FORD GLOBAL TECHNOLOGIES, LLC, Dearborn, MI (US)

(72) Inventors: Daewon HAN, New Hudson, MI (US); Chi PAIK, Grosse Ile, MI (US)

(21) Appl. No.: 18/816,544

(22) Filed: Aug. 27, 2024

(51) Int. Cl. H01M 50/516; B23K 26/21; H01M 50/204; H01M 50/249; H01M 50/296; H01M 50/562

(52) U.S. Cl. CPC H01M 50/516; B23K 26/21; H01M 50/204; H01M 50/249; H01M 50/296; H01M 50/562; H01M 2220/20

(57) ABSTRACT

In a high voltage vehicle electronics system, a battery includes a plurality of battery cells, each with two electrode foils. The electrode foils are laser welded to respective terminal tabs using a fillet weld. The terminal tabs may be connected to other electrical components, such as an inverter by bus bars or cables.

### TECHNICAL FIELD

This disclosure pertains to laser welding. More particularly, this disclosure pertains to laser welding of foil electrode tabs of battery cells to a terminal tab for an electric vehicle.

### BACKGROUND

Laser welding works on the principle of using a focused beam of light, typically generated by a laser source, to heat and melt the materials being joined. The laser beam is directed precisely onto the joint area, where it rapidly heats the material to its melting point, creating a weld pool. Once the laser energy is removed from a given region, the melted material solidifies, forming a strong bond between the parts.

Continuous wave laser welding involves the continuous emission of laser energy onto the workpiece without interruption. The focus region is continuously moved along the material. Pulsed laser welding involves emitting laser energy in short pulses, with each pulse lasting for a fraction of a second. The focus region is typically constant during a pulse and is moved to a different location between pulses.

Laser welding is a highly versatile joining process, but it presents unique challenges when working with materials like copper and aluminum due to their distinct properties. Copper and aluminum have relatively high thermal conductivities. This high thermal conductivity makes it challenging to achieve sufficient heating at the weld joint. Copper and aluminum are also highly reflective to infrared radiation, including the wavelength commonly used in many laser welding processes. This reflectivity can result in poor absorption of laser energy, leading to insufficient heating.

### SUMMARY

A method of welding includes stacking a plurality of metal foils to form a foil stack, placing a surface of the foil stack against a metal tab, and focusing energy from a laser on an edge of the foil stack. An edge of each metal foil is aligned along the edge of the foil stack. The tab extends beyond the edge of the foil stack. The energy from the laser creates a fillet weld fastening each of the metal foils to the tab. The focus point of the laser may be moved along the edge of the foil stack. The energy from the laser may be focused on the edge at an acute angle relative to the surface of the tab. A wavelength of the laser may be in the blue or green spectrum. The metal foils may be made of copper. The tab may be made of aluminum. The metal foils may be electrode tabs of battery cells.

A battery includes a plurality of battery cells and a first terminal tab. Each of the battery cells has a first electrode foil which is mechanically and electrically connected to the first terminal tab by a first fillet weld. Each battery cell may also have a second electrode foil mechanically and electrically connected to a second terminal tab by a second fillet weld. The first terminal tab may be made of aluminum. The first electrode foils may be made of copper.

A battery includes a plurality of battery cells and a first terminal tab. Each of the battery cells has a first electrode foil. The first electrode foils are stacked to form a first foil stack with edges of the first electrode foils aligned along an edge of the first foil stack. The first terminal tab is mechanically and electrically connected to the edges of each of the first electrode foils by a first fillet weld. Each of the battery cells may also have a second electrode foil. The second electrode foils may be stacked to form a second foil stack with edges of the second electrode foils aligned along an edge of the second foil stack. The battery may include a second terminal tab mechanically and electrically connected to the edges of each of the second electrode foils by a second fillet weld. The first electrode foils and the second electrode foils may be made of copper. The first terminal tab and the second terminal tab may be made of aluminum.

### BRIEF DESCRIPTION OF THE DRAWINGS

FIG. 1 illustrates a block diagram of an electric vehicle.

FIG. 2 illustrates a structure of a battery suitable for use in the electric vehicle of FIG. 1.

FIG. 3 is a cross-sectional view of a stack of battery cell electrode foils connected to a terminal tab using a lap weld.

FIG. 4 is a cross-sectional view of a stack of battery cell electrode foils connected to a terminal tab using a fillet weld.

FIG. 5 is a flowchart for a process of fabricating a battery.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

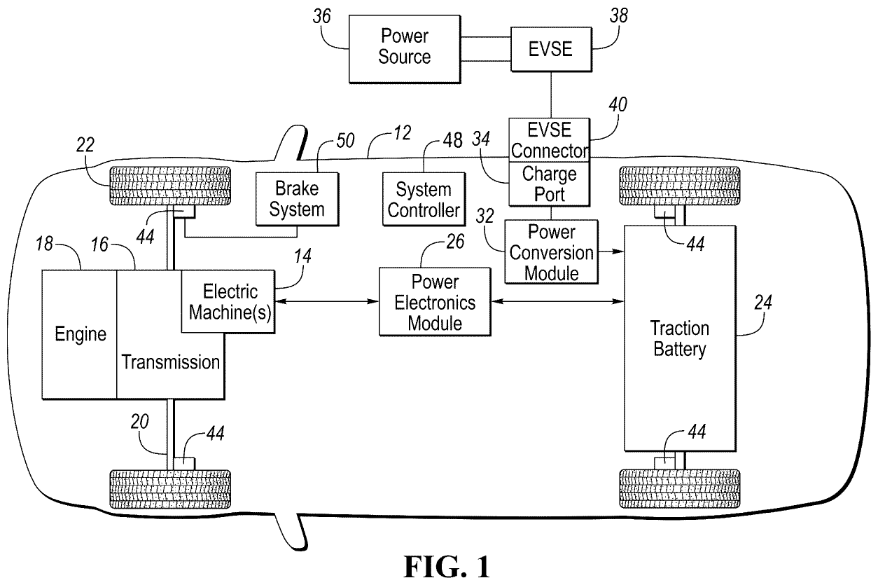

Referring now to FIG. 1, a block diagram of an exemplary electric vehicle (“EV”) 12 is shown. In this example, EV 12 is a plug-in hybrid electric vehicle (PHEV). EV 12 includes one or more electric machines 14 (“e-machines”) mechanically connected to a transmission 16. Electric machine 14 is capable of operating as a motor and as a generator. Transmission 16 is mechanically connected to an engine 18 and to a drive shaft 20 mechanically connected to wheels 22. Electric machine 14 can provide propulsion and slowing capability while engine 18 is turned on or off. Electric machine 14 may reduce vehicle emissions by allowing engine 18 to operate at more efficient speeds and allowing EV 12 to be operated in electric mode with engine 18 off under certain conditions.

A traction battery 24 (“battery) stores energy that can be used by electric machine 14 for propelling EV 12. Battery 24 typically provides a high-voltage (HV) direct current (DC) output. Battery 24 is electrically connected to a power electronics module 26. Power electronics module 26 is electrically connected to electric machine 14 and provides the ability to bi-directionally transfer energy between battery 24 and the electric machine. For example, battery 24 may provide a DC voltage while electric machine 14 may require a three-phase alternating current (AC) voltage to function. Power electronics module 26 may convert the DC voltage to a three-phase AC voltage to operate electric machine 14. In a regenerative mode, power electronics module 26 may convert three-phase AC voltage from electric machine 14 acting as a generator to DC voltage compatible with battery 24.

Battery 24 is rechargeable by an external power source 36 (e.g., the grid). Electric vehicle supply equipment (EVSE) 38 is connected to external power source 36. EVSE 38 provides circuitry and controls to control and manage the transfer of energy between external power source 36 and EV 12. External power source 36 may provide DC or AC electric power to EVSE 38. EVSE 38 may have a charge connector 40 for plugging into a charge port 34 of EV 12. Charge port 34 may be any type of port configured to transfer power from EVSE 38 to EV 12. A power conversion module 32 of EV 12 may condition power supplied from EVSE 38 to provide the proper voltage and current levels to battery 24. Power conversion module 32 may interface with EVSE 38 to coordinate the delivery of power to battery 24. Alternatively, various components described as being electrically connected may transfer power using a wireless inductive coupling.

The various components discussed may have one or more associated controllers to control and monitor the operation of the components. The controllers can be microprocessor-based devices. The controllers may communicate via a serial bus (e.g., Controller Area Network (CAN)) or via discrete conductors. For example, a system controller 48 (i.e., a vehicle controller) is present to coordinate the operation of the various components.

As described, EV 12 is in this example is a PHEV having engine 18 and battery 24. In other embodiments, EV 12 is a battery electric vehicle (BEV). In a BEV configuration, EV 12 does not include an engine.

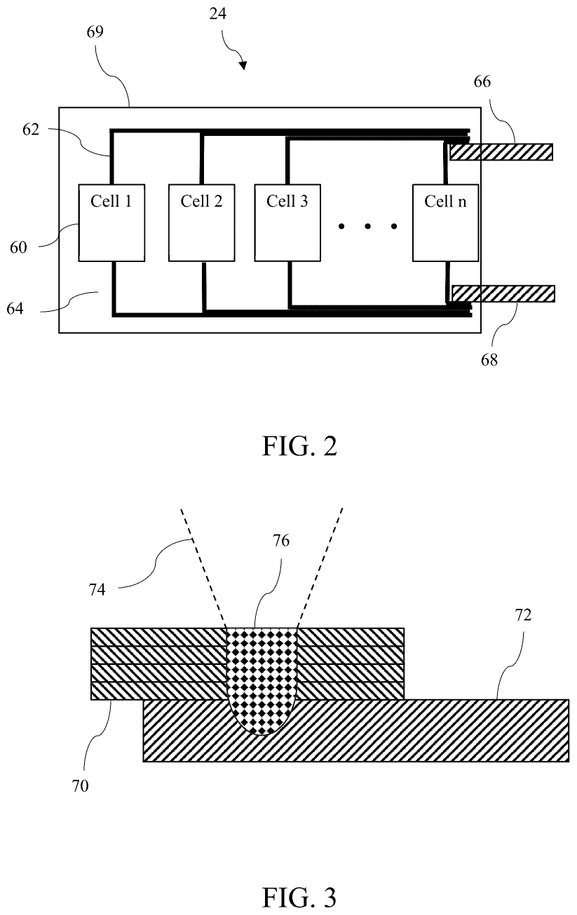

FIG. 2 illustrates a structure suitable for the traction battery 24. The battery may include a set of battery cells 60. Each battery cell 60 may include a positive electrode foil 62 and a negative electrode foil 64. The electrode foils may be copper, aluminum, or other electrically conductive material. Unlike rigid electrodes, the thickness of an electrode foil causes it to be flexible. Each positive electrode foil may be electrically connected to one another and to positive terminal tab 66 while each negative electrode foil may be electrically connected to one another and to negative terminal tab 68. A terminal tab is a rigid electrically conductive member which extends to the outside of the battery housing 69 to enable connection to other electrical components such as power electronics module 26 and power conversion module 32. The terminal tabs may be copper, aluminum, or other electrically conductive material which may be the same material as the corresponding electrode foils or may be a different material. The electrical connections may be formed by welding, such as laser welding.

In laser welding, two primary modes of operation are conductive mode and keyhole mode. These modes differ in their approach to material interaction and heat transfer, leading to distinct welding characteristics and applications.

In conductive mode laser welding, the laser beam's energy is primarily absorbed at the material's surface, causing localized heating. The beam is focused on a comparatively large area leading to a comparatively low energy density. The heat conducted through the material creates a shallow molten pool near the surface, where the fusion occurs. When the molten pool cools, it re-solidifies with a distinctly different grain pattern than the regions that were never melted. The re-solidified region bonds to each of the pieces being joined, thereby joining the pieces to one another both mechanically and electrically.

Keyhole mode laser welding involves the formation of a vapor-filled void or “keyhole” within the material's thickness. The beam is focused on a comparatively small area leading to a comparatively high energy density relative to conductive mode. The intense laser energy creates a localized vaporization of the material, forming a cavity that extends into the depth of the material. The keyhole acts as a channel for the laser beam to penetrate deeply into the material, allowing for significantly deeper weld penetration than conductive mode. As with conductive mode, when the molten pool cools, it re-solidifies with a distinctly different grain pattern, bonding mechanically and electrically to the pieces being joined.

FIG. 3 illustrates one method of laser welding a stack 70 of electrode foils to a terminal tab 72. One surface of the stack is held in contact with the terminal tab while a laser beam 74 is focused on a second surface of the stack opposite the terminal tab. The laser energy heats the material forming a melt pool 76 which extends through the stack 70 of foils into the terminal tab. After the laser beam is removed, the melt pool solidifies mechanically and electrically joining the foils to one another and to the terminal tab. The laser may be controlled to operate in either conductive mode or keyhole mode during this process. In some circumstances, the laser beam may be moved continuously along a path on the top surface of the stack. In other circumstances, the laser may be pulsed on and off, remaining in one place while on and being moved to a different location while off, thereby forming an array of separate welds. This method requires relatively high energy density to ensure that the melt pool penetrates the terminal tab. Weld quality issues are more likely when the energy density is high.

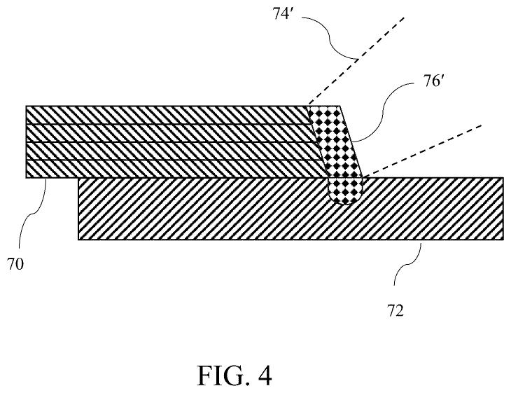

FIG. 4 illustrates an alternative method of laser welding a stack 70 of electrode foils to a terminal tab 72. The terminal tab 72 may be the positive terminal tab 66 or the negative terminal tab 68 of the battery of FIG. 2. The electrode foils that make up the foil stack 70 may be the positive electrode foils 62 or the negative electrode foils 64 of the battery cells 60 of the battery of FIG. 2. As in the first method, one surface of the stack is held in contact with the terminal tab. However, instead of focusing the laser beam on a surface of the stack opposite the terminal tab, the laser beam 74′ is focused on the ends of the foils. A surface formed by edges of the separate foils may be referred to as an edge surface of the foil stack 70. The laser beam may be oriented at an acute angle relative to the surface of the terminal tab and relative to the edge surface of the foil stack. Instead of creating a melt pool which extends through the stack of foils, a melt pool 76′ is formed at the edge surface and extending into the terminal tab. After the laser beam 74′ is removed, the melt pool solidifies mechanically and electrically joining the foils to one another and to the terminal tab. The solidified melt pool forms a fillet weld meaning that the altered grain structure is formed along surfaces of the two parts which intersect one another at an angle. For example, the two surfaces may intersect at a right angle. Specifically, the fillet weld is formed along the edge surface of the foil stack and a face surface of the terminal tab. The laser beam may either be moved continuously along the edge surface of the stack or may be pulsed. Since the weld pool does not need to be as deep for this method as for the method of FIG. 3, a lower energy laser beam may be employed. Wavelengths in the green/blue spectrum may be effective in applications for which they would not be effective with the method of FIG. 3.

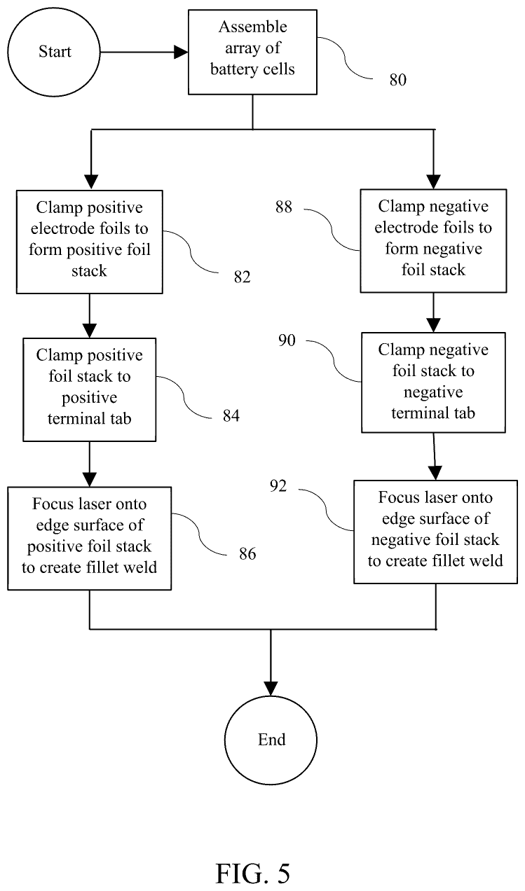

FIG. 5 illustrates a process for manufacturing a battery. At 80, battery cells are assembled into an array. This may include installing the battery cells into a housing 69. Each battery cell includes a positive electrode foil and a negative electrode foil. At 82, the positive electrode foils are gathered together and clamped to one another to form a positive foil stack. At 84, the positive foil stack is clamped to a positive terminal tab such that a surface of the terminal tab that is in contact with the foil stack extends beyond an edge surface of the foil stack. Alternatively, a single clamp may hold the positive electrode foils to one another and to the terminal tab. At 86, a laser is focused onto an edge surface of the positive foil stack to create a fillet weld between the positive foil stack and the positive terminal tab. The laser beam may be directed at an acute angle relative to a surface of the terminal tab that is in contact with the foil stack. A comparable procedure is completed to create a fillet weld between the negative electrode foils and the negative terminal tab at 88, 90, and 92.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method of welding comprising:
stacking a plurality of metal foils to form a foil stack, wherein an edge of each metal foil is aligned along an edge of the foil stack;
placing a surface of the foil stack against a surface of a metal tab such that the surface of the tab extends beyond the edge of the foil stack; and
focusing energy from a laser on the edge of the foil stack to create a fillet weld fastening each of the metal foils to the tab.

2. The method of claim 1 further comprising moving a focus of the laser along the edge of the foil stack.

3. The method of claim 1 wherein the energy from the laser is focused on the edge at an acute angle relative to the surface of the tab.

4. The method of claim 1, wherein the metal foils are made of copper.

5. The method of claim 1, wherein the tab is made of aluminum.

6. The method of claim 1, wherein each of the metal foils is an electrode of a battery cell.

7. The method of claim 1, wherein a wavelength of the laser is in a blue or green spectrum.

8. A battery comprising:
a plurality of battery cells, each having a first electrode foil; and
a first terminal tab; wherein
the first electrode foil of each battery cell of the plurality of battery cells is mechanically and electrically connected to the first terminal tab by a first fillet weld.

9. The battery of claim 8 further comprising:
a second terminal tab; wherein
each battery cell of the plurality of battery cells has a second electrode foil mechanically and electrically connected to the second terminal tab by a second fillet weld.

10. The battery of claim 8 wherein the first terminal tab is made of aluminum.

11. The battery of claim 8 wherein the first electrode foils are made of copper.

12. A battery comprising:
a plurality of battery cells, each of the battery cells having a first electrode foil, wherein the first electrode foils are stacked to form a first foil stack with edges of the first electrode foils aligned along an edge of the first foil stack; and
a first terminal tab mechanically and electrically connected to the edges of each of the first electrode foils by a first fillet weld.

13. The battery of claim 12 wherein each of the battery cells has a second electrode foil, wherein the second electrode foils are stacked to form a second foil stack with edges of the second electrode foils aligned along an edge of the second foil stack.

14. The battery of claim 13 wherein the first electrode foils and the second electrode foils are made of copper.

15. The battery of claim 13 further comprising a second terminal tab mechanically and electrically connected to the edges of each of the second electrode foils by a second fillet weld.

16. The battery of claim 15 wherein the first terminal tab and the second terminal tab are made of aluminum.
